(19) United States
(12) Patent Application Publication
(10) Pub. No.: US 2026/0282080 A1
(43) Pub. Date: Sep. 17, 2026

(54) Reporting Consistent Uplink Listen-Before-Talk Failures in Shared Channels

(71) Applicant: TELEFONAKTIEBOLAGET LM ERICSSON (PUBL), Stockholm (SE)

(72) Inventors: Ali Parichehrehteroujeni, Linköping (SE); Marco Belleschi, Solna (SE); Pradeepa Ramachandra, Linköping (SE)

(21) Appl. No.: 19/168,371

(22) PCT Filed: Apr. 5, 2024
(86) PCT No.: PCT/SE2024/050325

§ 371 Date: Sep. 24, 2025

Related U.S. Application Data
(60) Provisional application No. 63/494,538, filed on Apr. 6, 2023.

(51) Int. Cl. H04W 74/0808; H04W 74/0833

(52) U.S. Cl. CPC H04W 74/0808; H04W 74/0833

(57) ABSTRACT

Embodiments include methods for a user equipment (UE). Such methods include initiating an uplink (UL) transmission in an active first bandwidth (BWP) of a plurality of configured BWPs in unlicensed spectrum. The UL transmission is unrelated to a random access (RA) procedure. Such methods include detecting consistent listen-before-talk (LBT) failure in the first BWP and logging information associated with the first BWP in which the consistent LBT failure was detected. Such methods include repeating the following operations until an RA procedure in an active BWP succeeds or RA procedures fail in all configured BWPs having RA resources: deactivating the active BWP, activating another of the configured BWPs having RA resources, and performing an RA procedure in the active BWP. Such methods include sending to a radio access network (RAN) a report including at least the logged information associated with the first BWP. Other embodiments include complementary methods for RAN nodes. FIG. 7 is selected for publication.

### TECHNICAL FIELD

The present disclosure relates generally to wireless networks, and more specifically to techniques for improving the capability of a radio access network (RAN) to diagnose causes of events or operations reported by user equipment (UEs), particularly ones associated with listen-before-talk (LBT) failures in shared (or unlicensed) spectrum.

### BACKGROUND

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG-RAN nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each of the CUs and DUs can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

LTE Rel-10 introduced support for channel bandwidths larger than 20 MHz. To remain compatible with legacy UEs from earlier releases (e.g., Rel-8), a wideband LTE Rel-10 carrier appears as multiple component carriers (CCs), each having the same structure as an LTE Rel-8 carrier. A Rel-10 UE can receive the multiple CCs based on Carrier Aggregation (CA). The CCs can also be considered “cells”, such that a UE in CA has one primary cell (PCell) and one or more secondary cells (SCells). These are referred to collectively as a “cell group”. LTE Rel-12 introduced dual connectivity (DC) whereby a UE is connected simultaneously to a master node (MN) that provides a master cell group (MCG) and a secondary node (SN) that provides a secondary cell group (SCG). NR includes support for CA and DC in Rel-15 and subsequent releases.

Self-Organizing Networks (SON) is an automation technology used to improve the planning, configuration, management, optimization, and healing of mobile RANs. SON functionality can broadly be categorized as either self-optimization or self-configuration. Self-optimization employs UE and network measurements to auto-tune the RAN. This occurs when RAN nodes are in an operational state, after the node's RF transmitter interface is switched on. Self-configuration operations include optimization and adaptation, which are generally performed before the RAN nodes are in operational state.

Self-configuration and self-optimization features for NR networks are described in 3GPP TS 38.300 (v16.5.0) and for LTE networks in 3GPP TS 36.300 (v16.5.0). These features include dynamic configuration, automatic neighbor relations (ANR), mobility load balancing (MLB), mobility robustness optimization (MRO), random access channel (RACH) optimization, capacity and coverage optimization (CCO), and mobility settings change.

Seamless mobility is a key feature of 3GPP radio access technologies (RATs). In general, a RAN (e.g., NG-RAN) configures a UE to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE to declare radio link failure (RLF) or handover failure (HOF). This can occur before the UE sends a measurement report in a source cell, before the UE receives a handover command to a target cell, shortly after the UE executes a successful handover to the target cell, or upon a HOF to the target cell (e.g., upon expiry of timer T304, started when the UE starts synchronization with the target cell).

An RLF reporting procedure was introduced as part of the mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). 3GPP Rel-17 introduced a successful handover report (SHR) whereby a UE reports various information about a successful handover to a target cell. Both RLF reports and SHRs can include information about the UE's random access towards the target cell.

License Assisted Access (LAA) is an LTE feature that uses unlicensed 5-GHz spectrum in combination with licensed spectrum to deliver a performance boost for mobile device users. LAA uses DL carrier aggregation (CA) to combine LTE in licensed and unlicensed bands to provide better data rates and a better user experience. For example, in LAA, the UE's primary cell (PCell) is in a licensed band while the UE's secondary cells (SCells) can be in an unlicensed band. LAA uses a concept called Listen-before-talk (LBT) that dynamically selects 5-GHz-band channel(s) that is(are) not being used, i.e., a “clear channel.” As such, LBT is often referred to as clear channel assessment (CCA). If no clear channel is available, LAA will share a channel fairly with others.

NR Rel-16 includes a feature similar to LTE LAA, called NR-Unlicensed (NR-U). In contrast to LTE LAA, NR-U supports DC and standalone scenarios in which cooperative licensed spectrum is not available. In such scenarios, medium access control (MAC, e.g., random access) and scheduling procedures on unlicensed spectrum are subject to the LBT failures. This was not the case for LTE LAA, since MAC and scheduling procedures were performed in the licensed spectrum where LBT is unnecessary. Note the terms “shared” and “unlicensed” are used synonymously herein when referring to spectrum, unless stated otherwise.

When a UE wants to use any UL resources in a first bandwidth part (BWP) to transmit of unlicensed spectrum, the UE must perform LBT before accessing these UL resources. If the reason for accessing the UL resources is anything other than random access (RA) and if the UE finds the channel busy for a period (i.e., consistent LBT failure) then the UE switches to a second BWP where RA resources are available and tries to perform RA. If the UE finds the second BWP busy, then the UE switches to a third BWP with RA resources and tries to perform RA.

Upon finally performing RA successfully in a BWP, the UE logs RA-related information in a RA report, including information and measurements about the RA procedures performed in the various BWPs configured with RA resources in unlicensed spectrum. Currently, however, the UE does not log any information about the first BWP that the first consistent LBT failure occurred in which the UL transmission was not related to RA. Thus, such information is missing from the RA report the UE later sends to the network. A similar deficiency exists with respect to RLF reports sent by a UE after declaring RLF in unlicensed spectrum.

An object of embodiments of the present disclosure is to improve reporting of RA and RLF information by UEs operating in unlicensed spectrum, such as by providing, enabling, and/or facilitating solutions to overcome exemplary problems summarized above and described in more detail below.

Embodiments include methods (e.g., procedures) for a UE configured to operate in unlicensed spectrum in a radio access network (RAN, e.g., E-UTRAN, NG-RAN).

These exemplary methods can include initiating an UL transmission in an active first BWP of a plurality of configured BWPs in unlicensed spectrum. The UL transmission is unrelated to a random access (RA) procedure. These exemplary methods can also include detecting consistent LBT failure in the first BWP and logging information associated with the first BWP in which the consistent LBT failure was detected. These exemplary methods can also include repeating the following operations until an RA procedure in an active BWP succeeds or RA procedures fail in all configured BWPs having RA resources: deactivating the active BWP, activating another of the configured BWPs having RA resources, and performing a RA procedure in the active BWP.

These exemplary methods can also include subsequently sending to the RAN a report including at least the logged information associated with the first BWP.

In some embodiments, the logged information associated with the first BWP in which the consistent LBT failure was detected includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.
   In some of these embodiments, the one or more measurements of energy level in the first BWP include one or more of the following:
most recent energy level at the time of the consistent LBT failure in the first BWP,
average energy level at the time of the consistent LBT failure in the first BWP,
average energy level for successful LBT operations at the time of the consistent LBT failure in the first BWP, and
average energy level for failed LBT operations at the time of the consistent LBT failure in the first BWP.

In some embodiments, the exemplary method can also include logging information associated with each of the configured BWPs in which a RA procedure was performed. In such case, the report also includes the logged information associated with each of the configured BWPs in which a RA procedure was performed. In some of these embodiments, for each of the configured BWPs in which a RA procedure was performed, the logged information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

In some variants of these embodiments, the one or more measurements of energy level in the each of the configured BWPs in which a RA procedure was performed include one or more of the following:
most recent energy level at the time of performing RA in the BWP,
average energy level at the time of performing RA in the BWP,
average energy level for successful LBT operations at the time of performing RA in the BWP, and
average energy level for failed LBT operations at the time of performing RA in the BWP.

In some of these embodiments, in the report, the logged information associated with the first BWP and the logged information associated with each of the configured BWPs in which a RA procedure was performed are arranged in a chronological order in which the UE activated the respective BWPs.

In some embodiments, the repeated operations include one or more failed RA procedures in respective one or more configured BWPs other than the first BWP, with each failed RA procedure being due to consistent LBT failure. In some of these embodiments, the report also includes indications of respective durations between successive consistent LBT failures detected in the successive BWPs activated by the UE.

In some embodiments, the report also includes an indication of a duration from detecting the consistent LBT failure in the first BWP until either a successful RA procedure or failed RA procedures in all configured BWPs having RA resources.

In some embodiments, when the UE performs a successful RA procedure in one of the configured BWPs, the report is a RA report and the logged information is included in a RA-InformationCommon-r16 information element (IE). In other embodiments, when the UE performs failed RA procedures in all configured BWPs having RA resources, the report is a one of the following:
a radio link failure (RLF) report associated with an RLF or a handover failure;
an MCGFailureInformation report, associated with a failed MCG fast recovery procedure; or
an SCGFailureInformation report, associated with a SCG failure.
   In some of these embodiments, these exemplary methods can also include performing connection reestablishment with the RAN after failed RA procedures in all configured BWPs having RA resources. The report is transmitted after performing connection reestablishment.

In some embodiments, these exemplary methods can also include sending to the RAN an indication that the UE has stored information associated with consistent LBT failures and receiving from the RAN a request for the stored information. The report is sent in response to the request.

Other embodiments include exemplary methods (e.g., procedures) for a RAN node configured to serve UEs via a cell in unlicensed spectrum. In general, these exemplary methods can be complementary to the exemplary methods for a UE summarized above.

These exemplary methods can include receiving from a UE a report including at least information associated with a first BWP in which the UE detected consistent LBT failure. The first BWP is one of a plurality of BWPs configured for the UE in unlicensed spectrum, and the consistent LBT failure is detected for an UL transmission that is unrelated to a RA procedure. These exemplary methods can also include, based on the information in the report, adjusting one or more LBT configuration parameters for UEs in a cell served by the RAN node.

In various embodiments, the information included in the report can have the same content, structure, arrangement, etc. as summarized above for UE embodiments. Moreover, the report can be any of the report types summarized above for UE embodiments.

In some embodiments, these exemplary methods can also include performing connection reestablishment with the UE after failed UE RA procedures in all configured BWPs having RA resources. The report is received after performing connection reestablishment.

In some embodiments, these exemplary methods can also include receiving from the UE an indication that the UE has stored information associated with consistent LBT failures and sending to the UE a request for the stored information. The report is received in response to the request.

In some embodiments, adjusting one or more LBT configuration parameters for UEs based on the information in the report can include the following operations:
determining one or more of the following information based on the information in the report:
   BWPs in which the UE detected consistent UL LBT failure;
   how many BWP switches were performed by the UE due to consistent UL LBT failures;
   duration between consistent LBT failures in multiple BWPs,
   correlation between consistent LBT failures in multiple BWPs, and
   which portion of the UE's reported LBT failures occurred during RA procedures in the shared channel; and
adjusting RA configurations in BWPs in which the UE detected consistent UL LBT failure, based on the determined information.

Other embodiments include UEs (e.g., wireless devices) and RAN nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs and RAN nodes to perform operations corresponding to any of the exemplary methods described herein.

These and other embodiments described herein may provide various advantages, benefits, and/or solutions to problems. In general, embodiments may improve operation of UEs and RAN nodes in unlicensed spectrum. As an example, by receiving UE information and measurements pertaining to a first BWP in which the UE initially detected the consistent LBT failure, the RAN may create a more complete picture of consistent LBT failures detected by the UEs. Moreover, based on receiving information about the list of BWPs configured at the UE at the time of consistent LBT failure(s), the RAN may better understand UE behavior in selecting other BWPs upon detecting an initial consistent LBT failure, enabling the RAN to better allocate RA resources in configured BWPs. Furthermore, embodiments may enable the RAN to identify BWPs that are correlated for consistent LBT failures, so the RAN can avoid allocating RA resources in correlated BWPs. In this manner, the RAN may adjust and/or optimize UL LBT and/or RA settings for UEs operating in the cell based on the information reported by UEs.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 is a block diagram illustrating self-organization network (SON) functionality.

FIG. 5 shows an exemplary ASN.1 data structure for an RA-Report-r17 information element (IE), according to some embodiments of the present disclosure.

FIG. 6 shows an exemplary ASN.1 data structure for an RLF-Report-r17 IE, according to some embodiments of the present disclosure.

FIG. 7 shows a flow diagram of an exemplary method for a UE (e.g., wireless device), according to various embodiments of the present disclosure.

FIG. 8 shows a flow diagram of an exemplary method for a RAN node (e.g., base station, eNB, gNB, ng-eNB, etc.), according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows a host computing system according to various embodiments of the present disclosure.

FIG. 13 is a block diagram of a virtualization environment in which some embodiments of the present disclosure may be virtualized.

FIG. 14 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio access node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows another high-level view of an exemplary 5G network architecture, including NG-RAN (299) and 5GC (298). As shown in the figure, the NG-RAN can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to the Access and Mobility Management Functions (AMFs, e.g., 230a,b) via respective NG-C interfaces and to the User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) LTE radio interface. Unlike conventional LTE eNBs, however, ng-eNBs connect to the 5GC via the NG interface. Each of the gNBs and ng-eNBs can serve a geographic coverage area including one or more cells (e.g., 211a-b and 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is possible that one NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. Time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz or even larger for future NR releases.

An NR resource block (RB) consists of a group of 12 contiguous OFDM subcarriers for a duration of a 12- or 14-symbol slot. A resource element (RE) corresponds to one OFDM subcarrier during one OFDM symbol interval. An NR slot can also be arranged with various time-division duplexing (TDD) arrangements of UL and DL symbols. Each NR carrier can also be divided into multiple bandwidth parts (BWPs). A carrier BWP is a contiguous set of physical RBs according to the carrier's numerology (μ) or SCS, with further details provided in 3GPP TS 38.211(v17.4.0).

As briefly mentioned above, NR networks also provide coverage via “beams.” In general, a downlink (DL) “beam” is a coverage area of a network-transmitted RS that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

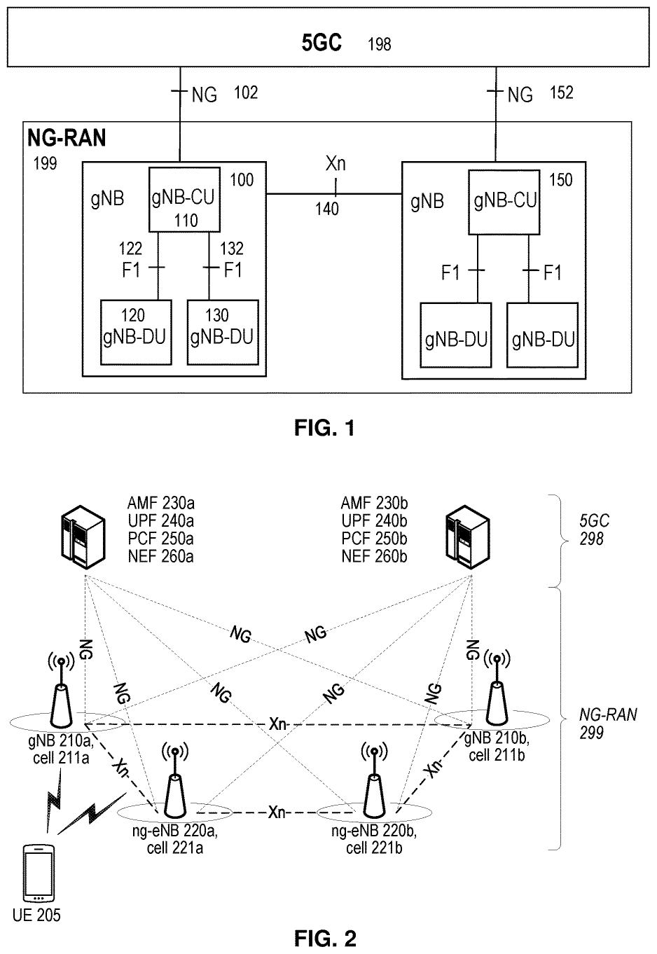

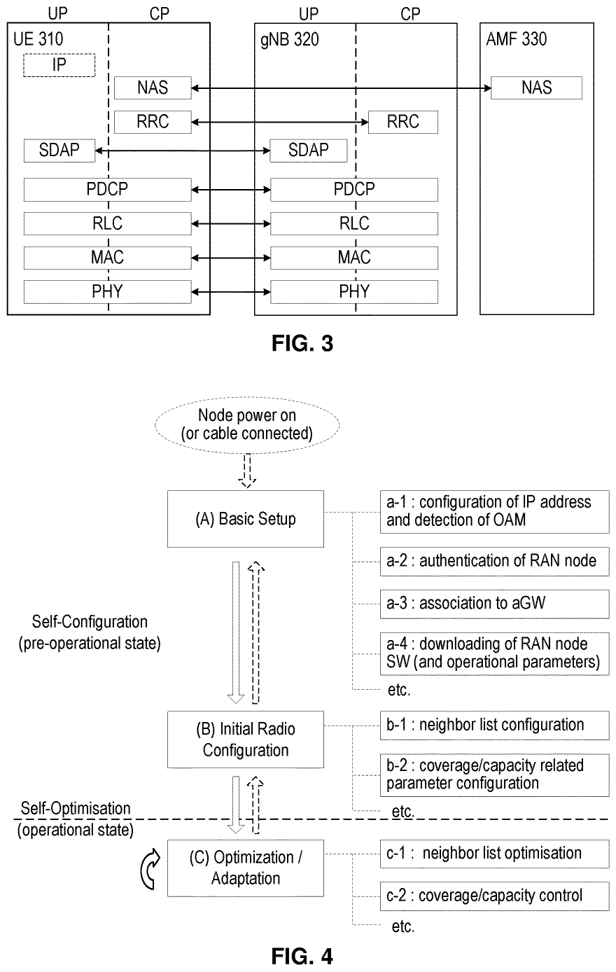

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On the CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB, An NR UE in RRC_IDLE state is not known to the gNB serving the cell where the UE is camping. However, NR RRC includes an RRC_INACTIVE state in which a UE is known (e.g., via UE context) by the serving gNB.

As briefly mentioned above, 3GPP Rel-12 introduced LTE dual connectivity (DC) in which a UE is connected simultaneously to a master node (MN) that provides a master cell group (MCG) and a secondary node (SN) that provides a secondary cell group (SCG). 3GPP TR 38.804 (v14.0.0) describes various exemplary DC scenarios or configurations in which the MN and SN can apply NR, LTE, or both.

Each cell group includes one MAC entity, a set of logical channels with associated RLC entities, a primary cell (PCell or PSCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG. In non-DC operation (e.g., carrier aggregation), SpCell refers to the PCell. An SpCell is always activated and supports physical uplink control channel (PUCCH) transmission and contention-based random access by UEs.

FIG. 4 is a block diagram illustrating self-organization network (SON) functionality, which is an automation technology used to improve the planning, configuration, management, optimization, and healing of mobile RANs. SON functionality can broadly be categorized as either self-optimization or self-configuration. Self-optimization employs UE and network measurements to auto-tune the RAN. This occurs when RAN nodes are in an operational state, after the node's RF transmitter interface is switched on. Self-configuration operations include optimization and adaptation, which are generally performed before the RAN nodes are in operational state.

Self-configuration and self-optimization features for NR networks are described in 3GPP TS38.300 (v16.5.0) and for LTE networks in 3GPP TS 36.300 (v16.5.0). These features include dynamic configuration, automatic neighbor relations (ANR), mobility load balancing (MLB), mobility robustness optimization (MRO), random access channel (RACH) optimization, capacity and coverage optimization (CCO), and mobility settings change.

Self-configuration is a pre-operational process in which newly deployed RAN nodes (e.g., eNBs or gNBs) in a pre-operational state are configured by automatic installation procedures to get the necessary basic configuration for system operation. Pre-operational state generally refers to the time when the node is powered up and has backbone connectivity until the node's RF transmitter is switched on. Self-configuration operations in pre-operational state include (A) basic setup and (B) initial radio configuration, which include the following sub-operations shown in FIG. 4:
(a-1) Configuration of IP address and detection of operations administration and maintenance (OAM);
(a-2) Authentication of RAN node;
(a-3) Associate to access gateway (aGW);
(a-4) Downloading of RAN node software (SW) and operational parameters;
(b-1) Neighbor list configuration; and
(b-2) Coverage/capacity-related parameter configuration.

Self-optimization is a process in which UE and network measurements are used to auto-tune the network. This occurs when the nodes are in operational state, which generally refers to when a node's RF transmitter interface is switched on. Self-configuration operations include optimization and adaptation, which includes the following sub-operations shown in FIG. 4:
(c-1) Neighbor list optimization; and
(c-2) Coverage/capacity control.

MLB involves coordination between two or more RAN nodes to optimize the traffic loads of their respective cells, thereby enabling a better use of radio resources available in a geographic area among served UEs. MLB can involve load-based handover of UEs between cells served by different nodes, thereby achieving “load balancing”.

CCO involves coordination between two or more RAN nodes to optimize the coverage and capacity offered by their respective cells. For example, a reduced coverage and/or capacity in a cell served by a first RAN node can be compensated by an increase in the coverage and/or capacity of neighboring cell served by a second RAN node.

Mobility settings change involves two RAN nodes negotiating a mutually agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. For example, a setting change for a handover trigger parameter can expand or shrink the UE's observed coverage area of a serving cell, thereby causing the UE to request a handover to a neighbor cell having a higher measured signal strength and/or quality.

Seamless mobility is a key feature of 3GPP radio access technologies (RATs). In general, a RAN (e.g., NG-RAN) configures a UE in RRC_CONNECTED state to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE will declare radio link failure (RLF) or handover failure (HOF).

A UE typically triggers an internal RLF procedure when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell and uses that information to decide whether the UE is in-sync (IS) or out-of-sync (OOS) with respect to that serving cell. If RLM (i.e., by L1/PHY) indicates number of consecutive OOS conditions to the RRC layer, then RRC starts an RLF procedure and declares RLF after expiry of a timer (e.g., T310). The L1 RLM procedure is carried out by comparing the estimated measurements to some targets Qout and Qin, which correspond to block error rates (BLERs) of hypothetical transmissions from the serving cell. Exemplary values of Qout and Qin are 10% and 2%, respectively. In NR, the network can define RS type (e.g., CSI-RS and/or SSB), exact resources to be monitored, and the BLER target for IS and OOS indications.

In case of handover failure (HOF) and RLF, the UE may take autonomous actions such as selecting a cell and initiating reestablishment to remain reachable by the network. In general, a UE declares RLF only when the UE realizes that there is no reliable radio link available between itself and the network, which can result in poor user experience. Also, reestablishing the connection requires signaling with a newly selected cell (e.g., random access procedure, exchanging various RRC messages, etc.), which introduces latency until the UE can again reliably transmit and/or receive user data with the network. Potential causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report;
4) Reaching a maximum number of RLC retransmissions;
5) Consistent UL LBT failures while operating in unlicensed spectrum; and
6) Failing a beam failure recovery (BFR) procedure.
   On the other hand, HOF is caused by expiry of T304 timer while performing the handover to the target cell.

Since RLF leads to reestablishment in a new cell and degradation of UE/network performance and end-user experience, it is in the interest of the network to understand the reasons for UE RLF and to optimize mobility-related parameters (e.g., trigger conditions of measurement reports) to reduce, minimize, and/or avoid subsequent RLFs. Before Rel-9 mobility robustness optimizations (MRO), only the UE was aware of radio quality at the time of RLF, the actual reason for declaring RLF, etc.

An RLF reporting procedure was introduced as part of mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). A corresponding RLF reporting procedure was introduced as part of MRO for NR Rel-16.

In this procedure, a UE logs relevant information at the time of RLF and later reports such information to the network via a target cell to which the UE ultimately connects (e.g., after reestablishment). The UE can store the RLF report in a UE variable call varRLF-Report and retains it in memory for up to 48 hours, after which it may discard the information.

When sending certain RRC messages such as RRCReconfigurationComplete, RRCReestablishmentComplete, RRCSetup-Complete, and RRCResumeComplete, the UE can indicate it has a stored RLF report by setting a rlf-InfoAvailable field to “true.” If the gNB serving the target cell wants to receive the RLF report, it sends the UE an UEInformationRequest message with a flag “rlf-ReportReq-r16”. In response, the UE sends the gNB a UEInformationResponse message that includes the RLF report.

In general, UE-reported RLF information can include any of the following:
Measurement quantities (RSRP, RSRQ) of the last serving cell (PCell).
Measurement quantities of the neighbor cells in different frequencies of different RATs (e.g., EUTRA, UTRA, GERAN, CDMA2000).
Measurement quantity (RSSI) associated to WLAN APs.
Measurement quantity (RSSI) associated to Bluetooth beacons.
Location information, if available (including location coordinates and velocity)
Globally unique identity of the last serving cell, if available, otherwise the PCI and the carrier frequency of the last serving cell.
Tracking area code of the PCell.
Time elapsed since the last reception of the ‘Handover command’ message.
C-RNTI used in the previous serving cell.
Whether or not the UE was configured with a DRB having QCI=1.

Based on a UE RLF report and knowledge of the cell in which the UE reestablished its connection, the RAN node serving the UE's original source cell can deduce whether the RLF was due to a coverage hole or handover-related parameter configurations. If the latter case, the RAN node serving the UE's original source cell can also classify the handover-related failure as too-early, too-late, or wrong-cell. These classes are described in more detail below.

The RAN node can classify a handover failure as “too late handover” when the original source cell fails to send the UE a command to handover to a particular target cell and if the UE ultimately reestablishes itself in this same target cell (i.e., post RLF). An example corrective action by the RAN node serving the UE's original source cell is to initiate handovers towards this target cell slightly earlier, such as by decreasing the cell individual offset (CIO) towards the target cell. Note that CIO controls when the UE sends the RAN node an event-triggered measurement report that causes the RAN node to make a handover decision.

The RAN node can classify a handover failure as ‘too early handover’ when the original source cell successfully sends the UE a command to handover to a particular target cell but the UE fails to perform RA towards this target cell. An example corrective action by the RAN node serving the UE's original source cell is to initiate handovers towards this target cell slightly later, such as by increasing CIO to cause the UE to send the event-triggered measurement report slightly later.

The RAN node can classify a handover failure as “wrong cell handover” when the original serving cell intends to perform the handover for this UE towards a particular target cell but the UE instead declares RLF and reestablishes its connection in a different cell. Example corrective actions by the RAN node serving the UE's original source cell include initiating the UE measurement reporting procedure that leads to handover towards the target cell slightly later (e.g., by decreasing CIO for that cell) or initiating the handover towards the other cell in which the UE reestablished its connection slightly earlier (e.g., by increasing CIO for that cell).

NR Rel-15 introduced beam failure detection (BFD) and beam failure recovery (BFR). The serving RAN node configures a UE with BFD reference signals (e.g., SSB or CSI-RS) to be monitored, and the UE declares beam failure when a quantity of beam failure indications from L1 reaches a configured threshold before a configured timer expires. After BFD, the UE initiates a RA procedure in the serving cell and selects a suitable beam to perform BFR. In a multi-beam serving cell, RLF occurs when the UE is unable to find any suitable beam within the serving cell to recover the UE's failed connection. In contrast, RLF is prevented by the UE's successful BFR to another beam in the same cell.

3GPP Rel-17 introduced a successful handover report (SHR, also referred to as handover success report) that will be sent by UE to network upon successful execution of a handover command. In particular, 3GPP has defined an SHR configuration that a UE applies in an RRC CONNECTED state to report information (e.g., measurements about a successful handover) under some specific conditions that are configured by the network.

For example, when any of timers T310/T312/T304 exceed corresponding thresholds during a handover, then the UE stores information associated with this handover. As another example, when the UE succeeded with a dual active protocol stack (DAPS) handover but experienced an RLF in the source cell, then the UE stores information associated with this handover. When storing the SHR, the UE may include various information to aid network analysis and optimization, such as measurements of the neighbouring cells, condition(s) that triggered the SHR (e.g., T310 threshold exceeded, RLF cause in the source cell during DAPS HO), etc.

The SHR can be configured by a RAN node serving the UE in a source cell and once triggering conditions are met, the UE stores relevant SHR information until requested by the RAN. In particular, the UE may indicate availability of SHR information in messages such as RRCReconfigurationComplete, RRCReestablishmentComplete, RRCSetupComplete, RRCResumeComplete, etc. The RAN may request SHR information via UEInformationRequest message and the UE provides the stored SHR via UEInformationResponse message.

As mentioned above, both SHR and RLF reports can include information (e.g., RA Information) about the UE's random access towards a target cell, such as when random access is the source of the RLF or triggered UE collection of SHR information. The RA information can include information about the BWP in which the RA was attempted, DL pathloss experienced at the time of initiating the RA procedure, information related to each RA preamble transmission attempt (e.g., whether contention was experienced, number of preamble transmission attempts in a certain SSB or CSI-RS, etc.). This allows the network to understand the UE's random access-related problem or issue and possibly address it.

Besides conventional use in licensed (i.e., exclusive) spectrum, NR networks also can operate in unlicensed bands in shared spectrum, referred to generally as NR-U. Operation in unlicensed bands introduces a unique set of rules intended to promote spectrum sharing with otherwise competing transceivers. These rules promote an etiquette or behavior that facilitates spectrum sharing and/or co-existence. According to a common coexistence technique, for a node (e.g., UE or base station) to be allowed to transmit in unlicensed spectrum, it typically needs to perform a listen-before-talk (LBT) or a clear channel assessment (CCA). For example, in the 5 GHz band, the sensing is done over 20-MHz channels. In general, the MAC layer initiates a transmission and requests the PHY layer to initiate the LBT procedure. After completion, the PHY layer indicates the LBT outcome (e.g., success or failure). This procedure can include sensing the medium as idle for a number of time intervals, which can be done in various ways including energy detection, preamble detection, or virtual carrier sensing.

LBT has become well-known and popular due to ubiquitous use by Wireless LANs (also known as “WiFi”), even though most regulatory agencies did not enforce LBT requirements. The introduction of LTE LAA and subsequent definition of LTE LAA regulations ensured LBT functionality was required by all radio transceivers, regardless of whether they were WiFi or LTE LAA. Energy detection (ED) thresholds were defined, simulated, debated, and soon became part of the regulatory specifications to be met by all devices that operate in unlicensed bands.

As an example of energy detection (ED), a channel is assessed to be idle when the received energy or power during the sensing time duration is below a certain ED threshold; otherwise, the channel is considered busy. Regulatory requirements in some regions specify the maximum allowed ED threshold, thus setting a limit on transmitter behavior. An example ED threshold is −72 dBm. In some cases, the ED threshold may depend on the channel bandwidth, e.g., −72 dBm 20 MHz bandwidth, −75 dBm for 10 MHz bandwidth, etc. If the channel is assessed as “busy” then the prospective transmitter (i.e., UE or network node) is required to defer transmission.

NR Rel-16 includes a feature similar to LTE LAA, called NR-Unlicensed (NR-U). In contrast to LTE LAA, NR-U supports DC and standalone scenarios in which cooperative licensed spectrum is not available. In such scenarios, medium access control (MAC, e.g., random access) and scheduling procedures on unlicensed spectrum are subject to the LBT failures. 3GPP TR 38.889 (v16.0.0) specifies the following four categories of channel access schemes for NR-U:
Cat-1 (also referred to as no LBT): Immediate transmission after a short switching gap. This is used for a transmitter to immediately transmit after a UL/DL switching gap inside a COT. The switching gap from reception to transmission is to accommodate the transceiver turnaround time and is no longer than 16 μs.
Cat-2 (also referred to as one shot LBT): LBT without random back-off. The duration of time that the channel is sensed to be idle before the transmitting entity transmits is deterministic.
Cat-3: LBT with random back-off with a contention window of fixed size. The transmitting entity draws a random number N within a contention window, whose size is fixed based on the minimum and maximum values of N. The random number N is used in the LBT procedure to determine the duration of time that the channel is sensed to be idle before the transmitting entity transmits on the channel.
Cat-4 (also referred to as dynamic channel occupancy with load based LBE): LBT with random back-off with a contention window of variable size. The transmitting entity draws a random number N within a contention window, whose size is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

Different categories of channel access schemes can be used for different transmissions in a COT and for different channels/signals to be transmitted. NR-U also supports two different LBT modes: dynamic channel occupancy for load based Equipment (LBE) and semi-static channel occupancy for frame based equipment (FBE).

In NR-U, a UE may declare RLF or HOF due to consistent uplink (UL) LBT failures resulting from RA procedures in multiple BWPs of a target cell (e.g., PCell or PSCell). The UE increments an LBT counter whenever an UL transmission fails in a currently active BWP. When the LBT counter reaches a maximum value within a certain duration, the UE declares “consistent LBT failure” for the active BWP. If the affected BWP is in the PCell or PSCell, the UE deactivates the affected BWP, activates another configured BWP in the PCell/PSCell with RA resources, and performs RA in the newly activated BWP. On the other hand, if the affected BWP is an SCell, the UE stops transmitting in the affected SCell and can transmit a scheduling request (SR) in another serving cell that has not experienced consistent UL LBT failures.

Additionally, the UE transmits a MAC CE to the RAN to indicate the cells in which consistent LBT failures occurred. Once the UE has attempted RA in all configured PCell BWPs with RA resources without success, the UE declares RLF and may attempt reestablishment. Similarly, the UE declares SCG failure when consistent UL LBT failures have occurred in all configured PSCell BWPs with RA resources.

To summarize the above discussion, when a UE wants to use any UL resources to transmit in unlicensed spectrum, the UE must perform LBT before accessing these UL resources. If the reason for accessing the UL resources is anything other than random access (RA) and if the UE finds the channel busy for a period (i.e., consistent LBT failure) then the UE switches to a second BWP where RA resources are available and tries to perform RA. If the UE finds the second BWP to be busy, then the UE switches to a third BWP with RA resources and tries to perform RA.

Upon finally performing RA successfully in a BWP, the UE logs RA-related information in a RA report, including information and measurements about the RA procedures performed in the various BWPs configured with RA resources in unlicensed spectrum. Currently, however, the UE does not log any information about the first BWP that the first consistent LBT failure occurred in which the UL transmission was not related to RA. Rather, it is agreed in 3GPP that a UE should “log the last successful RA procedure related information in the RA report. Only some information to be logged for multiple successive RA procedures failed due to LBT issue.”

Thus, such information is missing from the RA report the UE later sends to the network. A similar deficiency exists with respect to RLF reports sent by a UE after declaring RLF in unlicensed spectrum. Without such information, the RAN is unable to understand the UE's RA situation that led to the RA report or the RLF report.

Accordingly, embodiments of the present disclosure provide flexible and efficient techniques whereby a UE logs (or stores) information associated with all UL BWPs in which the UE detected consistent LBT failure, including a first (or initial) UL BWP in which the consistent LBT failure was unrelated to a RA by the UE. The UE then sends the logged RA information in an appropriate report, such as an RLF report or an RA report sent in an RRC UEInformationResponse message.

Embodiments of the present disclosure may provide various advantages, benefits, and/or solutions to problems. For example, by receiving UE information and measurements pertaining to the first BWP in which the UE detected the consistent LBT failure, the RAN may create a more complete picture of the consistent LBT failures detected by the UEs. Moreover, based on receiving information about the list of BWPs configured at the UE at the time of the consistent LBT failure(s), the RAN may better understand UE behavior in selecting other BWPs upon detecting consistent LBT failure in the first UL BWP, enabling the RAN to better allocate RA resources in configured BWPs.

Furthermore, based on the reported information, the RAN may identify BWPs that are correlated for consistent LBT failures. As an example, if multiple UEs report information related to BWP-1, BWP-2, and BWP-3 in that chronological order, then the RAN may infer that the LBT failures in BWP-1 and BWP-2 are correlated and can configure or adjust its RA resources accordingly. For example, the RAN may allocate RA resources in only one of correlated BWP-1 or BWP-2, so that any UL failures in other BWPs (e.g., BWP-3) would result in UE attempting LBT using RA resources in only one of the correlated BWPs, rather than both. This can speed up LBT failure recovery by UEs.

Since LBT failures may have occurred in the RA procedure itself, the RAN may adjust and/or optimize RA performance in the respective BWPs in which the UE attempted RA. In some embodiments, the RAN may also determine the respective portions of the UE's LBT failures that occurred in RA and in UL transmissions for other channels. In this manner, the RAN may adjust and/or optimize LBT and/or RA settings for UEs operating in the cell based on the RA information reported by UEs.

Some embodiments of the present disclosure involve procedures performed by a UE while operating in unlicensed spectrum in a RAN. The UE can perform the following operations in these embodiments:
initiating an UL transmission in an active first BWP of a cell, wherein the UL transmission unrelated to a RA procedure;
detecting consistent LBT failure in the first BWP;
logging information associated with the first BWP in which the consistent LBT failure was detected, including one or more of the following:
   location and bandwidth of the first BWP;
   subcarrier spacing of the first BWP;
   number of LBT failures detected in the first BWP, e.g., in a limited duration before the consistent LBT failure, since the UE started using the first BWP, etc.
   indication of whether the number of LBT failures detected in the first BWP is larger than a threshold;
   a BWP ID associated with the first BWP
   measurements of energy level in the first UL BWP, including one or more of the following:
      most recent energy level at the time of the consistent LBT failure in the first BWP,
      average energy level at the time of the consistent LBT failure in the first BWP,
      average energy level for successful LBT operations at the time of the consistent LBT failure in the first BWP,
      average energy level for failed LBT operations at the time of the consistent LBT failure in the first BWP,
   reason for initiating the UL transmission in the first BWP;
when the UE is configured with at least a second BWP having RA resources, deactivating the first BWP, activating the second BWP, and performing a RA procedure in the second BWP;
when the UE is not configured with at least a second BWP having RA resources or upon failure of UE RA procedures in all of the UE's configured BWPs having RA resources (e.g., due to consistent LBT failures), declaring RLF based on the unresolved consistent LBT failure; and
transmitting the logged information to the RAN in a message such as an RLF report, which may be done upon request by the RAN after a successful RA procedure performed by the UE during connection re-establishment.

In some embodiments, the UE can also log the following information associated with other configured BWPs in which the UE performed a failed RA procedure: respective locations and bandwidths, respective subcarrier spacings, and respective BWP IDs. In some of these embodiments, the UE can log this information in a chronological order of switching between the BWPs to perform RA procedures. For example, in a chronological order, the first entry is associated with the first BWP, the second entry is associated with the configured BWP in which the UE initially performed a failed RA procedure, the third entry is associated with the configured BWP in which the UE next performed a failed RA procedure, etc.

In some of these embodiments, the UE can log durations between successive consistent LBT failures detected in the various BWPs according to the chronological order. In other embodiments, the UE can log a duration from detecting the consistent LBT failure in the first BWP until performing a successful RA procedure, e.g., during connection re-establishment.

In some embodiments, the UE's logging of some or all of the above-listed information can be conditioned upon performing a successful RA procedure during connection re-establishment, after the UE transitions to RRC_IDLE mode.

In addition to an RLF report in response to declaring RLF, the message including the logged information can be any of the following in response to declaring corresponding events:
RLF report, in response to declaring HOF due to unresolved consistent LBT failure;
MCGFailureInformation, in response to declaring MCG failure due to unresolved consistent LBT failure in MCG (e.g., in PCell as part of fast MCG recovery); and
SCGFailureInformation, in response to declaring SCG failure in DC due to unresolved consistent LBT failure in SCG (e.g., in PSCell).

Other embodiments of the present disclosure involve other procedures performed by a UE while operating in unlicensed spectrum in a RAN. The UE can perform the following operations in these embodiments:
initiating an UL transmission in an active first BWP of a cell, wherein the UL transmission unrelated to a RA procedure;
detecting consistent LBT failure in the first BWP;
logging information associated with the first BWP in which the consistent LBT failure was detected, including one or more of the following:
   location and bandwidth of the first BWP;
   subcarrier spacing of the first BWP;
   number of LBT failures detected in the first BWP, e.g., in a limited duration before the consistent LBT failure, since the UE started using the first BWP, etc.
   indication of whether the number of LBT failures detected in the first BWP is larger than a threshold;
   a BWP ID associated with the first BWP
   measurements of energy level in the first BWP, including one or more of the following:
      most recent energy level at the time of the consistent LBT failure in the first BWP,
      average energy level at the time of the consistent LBT failure in the first BWP,
      average energy level for successful LBT operations at the time of the consistent LBT failure in the first BWP,
      average energy level for failed LBT operations at the time of the consistent LBT failure in the first BWP;
   reason for initiating the UL transmission in the first BWP;
when the UE is configured with at least a second BWP having RA resources, deactivating the first BWP, activating the second BWP, and performing a RA procedure in the second BWP;
when the RA procedure in one of the UE's configured BWPs is successful, logging the following information for each of the other BWPs toward which the UE performed RA after the detected LBT failure:
   respective locations and bandwidths of the other BWPs;
   respective subcarrier spacings of the other BWPs;
   respective numbers of LBT failures detected in the other BWPs;
   respective BWP IDs associated with the other BWPs;
   respective measurements of energy level in the other BWPs, including one or more of the following:
      most recent energy level in the BWP at the time of performing RA,
      average energy level in the BWP during a period including the time of performing RA,
      average energy level in the BWP for successful LBT operations at the time of performing RA,
      average energy level in the BWP for failed LBT operations at the time of performing RA,
   transmitting the logged information to the RAN in a message such as an RA report.

In some of these embodiments, the UE can log the information for the first BWP and the other BWPs in which the UE performed RA in a chronological order of switching between the BWPs. For example, in a chronological order, the first entry is associated with the first BWP, the second entry is associated with the configured BWP in which the UE initially performed a failed RA procedure, and the third entry is associated with the configured BWP in which the UE performed a successful RA procedure.

In some of these embodiments, the UE can log durations between successive consistent LBT failures detected in the various BWPs according to the chronological order. In some embodiments, the UE can log a duration from detecting the consistent LBT failure in the first BWP until performing a successful RA procedure in one of the other configured BWPs.

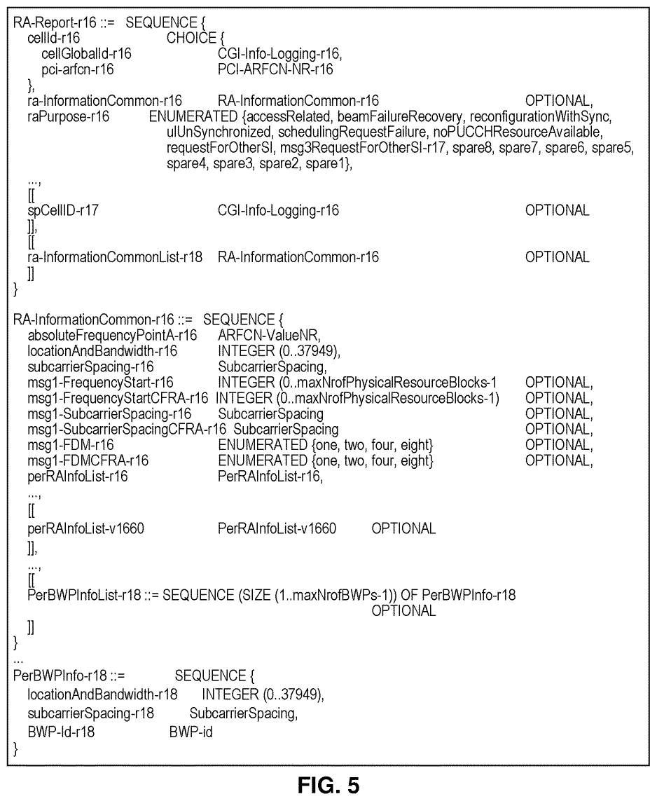

Certain embodiments can be realized as 3GPP specifications of message, information elements (IEs), and/or fields transmitted by a UE. FIG. 5 shows an exemplary ASN.1 data structure for an RRC RA-Report-r16 IE sent by a UE, according to some embodiments of the present disclosure. Ellipses indicate existing fields omitted for conciseness. For example, this IE can be included in a UEInformationResponse message sent in response to a UEInformationRequest message from the RAN. In relation to various embodiments described above, this IE includes RA-InformationCommon-r16, a data structure that includes various RA-related information. In particular, this data structure includes a perBWPInfoList-r18 IE, which is a sequence of perBWPInfo-r18 fields in a chronological order in which the UE accessed the corresponding BWPs. The first perBWPInfo-r18 field includes information for the first BWP in which the UE detected consistent LBT failure before initiating RA in other configured BWPs with RA resources. In particular, each perBWPInfo-r18 field includes the following information:
locationAndBandwith-r18, an integer value which indicates the location (in frequency spectrum) and bandwidth of the BWP;
subcarrierSpacing-r18, which indicates the subcarrier spacing (e.g., in kHz) of the BWP;
BWP-Id-r18, which includes the BWP ID associated with the BWP.

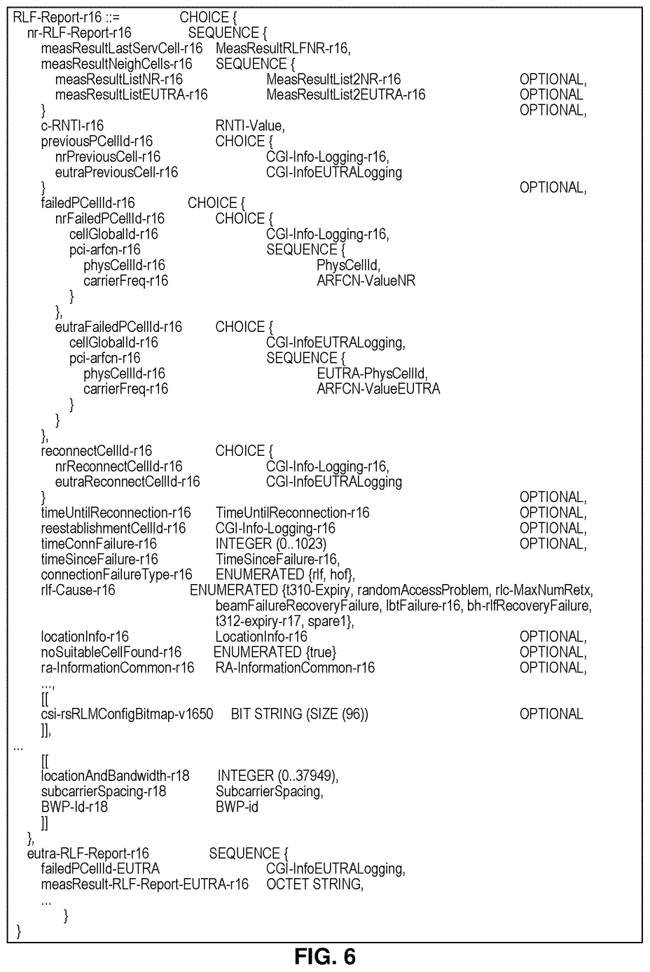

As another example, FIG. 6 shows an exemplary ASN.1 data structure for an RRC RLF-Report-r16 IE sent by a UE, according to some embodiments of the present disclosure. Ellipses indicate existing fields omitted for conciseness. For example, this IE can be included in a UEInformationResponse message sent in response to a UEInformationRequest message from the RAN. In relation to various embodiments described above, this IE does not include a RA-InformationCommon-r16 data structure (indicated as “optional”) but includes the following information in the higher-level nr-RLF-Report-r16 data structure:
locationAndBandwith-r18, an integer value which indicates the location (in frequency spectrum) and bandwidth of the first BWP in which the UE detected consistent LBT failure;
subcarrierSpacing-r18, which indicates the subcarrier spacing (e.g., in kHz) of the first BWP in which the UE detected consistent LBT failure;
BWP-Id-r18, which includes the BWP ID associated with the first BWP in which the UE detected consistent LBT failure.

Certain embodiments can be realized as procedural text in 3GPP specifications, which specify UE and/or RAN implementation. A first example is given below for embodiments in which a UE stores random access information associated with multiple random access procedures in an RA-InformationCommon IE, such as illustrated in FIG. 5. The following exemplary text for 3GPP TS 38.331 illustrates UE determination of RA-InformationCommon IE content according to embodiments of the present disclosure. Note that certain existing portions of this section below have been omitted for conciseness, as indicated by ellipses.

*** Begin exemplary text for 3GPP TS 38.331 ***
5.7.10.5 RA information determination
The UE shall set the content in ra-InformationCommon as follows:
1>set the absoluteFrequencyPointA to indicate the absolute frequency of the reference resource block associated to the random-access resources used in the random-access procedure;
1>set the locationAndBandwidth and subcarrierSpacing associated to the UL BWP of the random-access resources used in the random-access procedure;
1>if contention based random-access resources are used in the random-access procedure:
. . .
1>if contention free random-access resources are used in the random-access procedure:
. . .
1>if the random access procedure is initialized with RA_TYPE set to 2-stepRA as described in TS 38.321 [3]:
. . .
1>if the purpose of the random access procedure is to request on-demand system information (i.e., if the raPurpose is set to requestForOtherSI or msg3RequestForOtherSI):
. . .
1>set the parameters associated to individual random-access attempt in the chronological order of attempts in the perRAInfoList as follows:
. . .
1>if the RA procedure is triggered due to detection of consistent LBT failure in a first configured uplink BWP:
   2>set the BWP information of the first BWP in which the UE detected the first consistent LBT failure before initiating the RA procedure and the other BWPs in which the UE switched to recover from the consistent LBT failure in a chronological order of switching as follows:
      3>set the locationAndBandwidth and subcarrierSpacing associated to the UL BWP;
      3>set the BWP-Id associated to the UL BWP.
         *** End exemplary text for 3GPP TS 38.331 ***

A second example is given below for embodiments in which a UE does not include an RA-InformationCommon IE in an RLF report, but still includes information about a BWP in which consistent LBT failure occurred that led to declaring RLF, such as illustrated in FIG. 6. The following exemplary text for 3GPP TS 38.331 illustrates UE determination of VarRLF-Report content according to embodiments of the present disclosure. Note that certain existing portions of this section below have been omitted for conciseness, as indicated by ellipses.

*** Begin exemplary text for 3GPP TS 38.331 ***
5.3.10.5 RLF report content determination
The UE shall determine the content in the VarRLF-Report as follows:
1>clear the information included in VarRLF-Report, if any;
. . .
1>if connectionFailureType is rlf and the rlf-Cause is set to randomAccessProblem or beamFailureRecoveryFailure or IbtFailure; or
1>if connectionFailure Type is hof and if the failed handover is an intra-RAT handover:
   2>set the ra-InformationCommon to include the random-access related information as described in clause 5.7.10.5;
1>if available, set the locationInfo as in 5.3.3.7.
1>if ra-InformationCommon is not included in the RLF report and if the RLF is declared upon consistent LBT failure:
   2>set the locationAndBandwidth, subcarrierSpacing and BWP-Id of the BWP in which the UE detected the consistent LBT failure.
      The UE may discard the radio link failure information or handover failure information, i.e., release the UE variable VarRLF-Report, 48 hours after the radio link failure/handover failure is detected. NOTE 2: In this clause, the term ‘handover failure’ has been used to refer to ‘reconfiguration with sync failure’.
      *** End exemplary text for 3GPP TS 38.331 ***

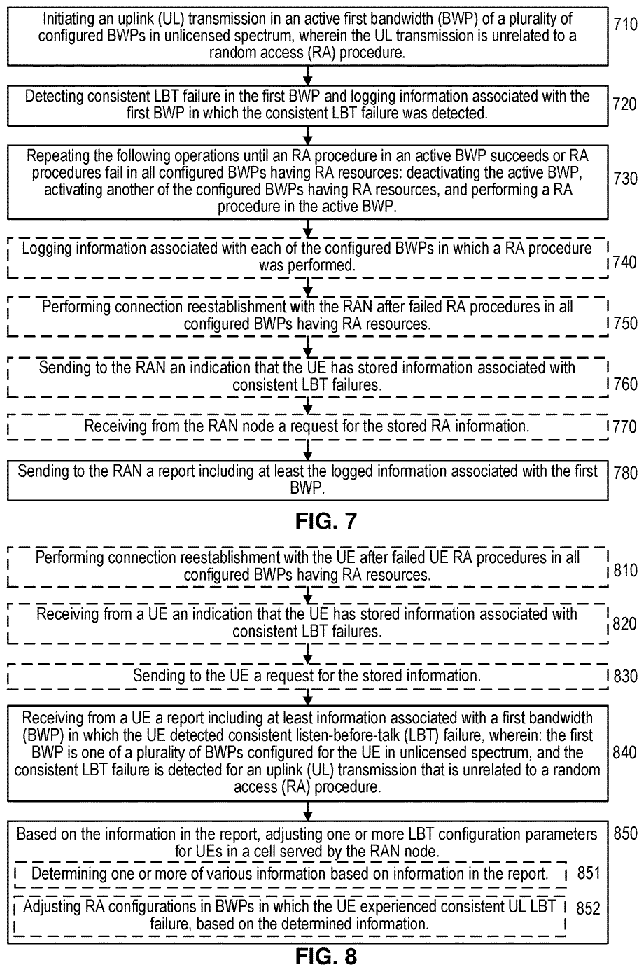

Various features of the embodiments described above correspond to various operations illustrated in FIGS. 7-8, which show exemplary methods (e.g., procedures) for a UE and a RAN node, respectively. In other words, various features of the operations described below correspond to various embodiments described above. Furthermore, the exemplary methods shown in FIGS. 7-8 can be used cooperatively to provide various benefits, advantages, and/or solutions to problems described herein. Although FIGS. 7-8 show specific blocks in particular orders, the operations of the exemplary methods can be performed in different orders than shown and can be combined and/or divided into blocks having different functionality than shown. Optional blocks or operations are indicated by dashed lines.

In particular, FIG. 7 shows an exemplary method (e.g., procedure) for a UE configured to operate in unlicensed spectrum in a RAN, according to various embodiments of the present disclosure. The exemplary method can be performed by a UE (e.g., wireless device) such as described elsewhere herein.

The exemplary method includes the operations of block 710, where the UE initiates an UL transmission in an active first BWP of a plurality of configured BWPs in unlicensed spectrum. The UL transmission is unrelated to a random access (RA) procedure. The exemplary method also includes the operations of block 720, where the UE detects consistent LBT failure in the first BWP and logs information associated with the first BWP in which the consistent LBT failure was detected. The exemplary method also includes the operations of block 730, where the UE repeats the following operations until an RA procedure in an active BWP succeeds or RA procedures fail in all configured BWPs having RA resources: deactivating the active BWP, activating another of the configured BWPs having RA resources, and performing a RA procedure in the active BWP.

The exemplary method also includes the operations of block 780, where the UE subsequently sends to the RAN a report including at least the logged information associated with the first BWP.

In some embodiments, the logged information associated with the first BWP in which the consistent LBT failure was detected includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.
   In some of these embodiments, the one or more measurements of energy level in the first BWP include one or more of the following:
most recent energy level at the time of the consistent LBT failure in the first BWP,
average energy level at the time of the consistent LBT failure in the first BWP,
average energy level for successful LBT operations at the time of the consistent LBT failure in the first BWP, and
average energy level for failed LBT operations at the time of the consistent LBT failure in the first BWP.

In some embodiments, the exemplary method also includes the operations of block 740, where the UE logs information associated with each of the configured BWPs in which a RA procedure was performed. In such case, the report (e.g., in block 780) also includes the logged information associated with each of the configured BWPs in which a RA procedure was performed. In some of these embodiments, for each of the configured BWPs in which a RA procedure was performed, the logged information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

In some variants of these embodiments, the one or more measurements of energy level in the each of the configured BWPs in which a RA procedure was performed include one or more of the following:
most recent energy level at the time of performing RA in the BWP,
average energy level at the time of performing RA in the BWP,
average energy level for successful LBT operations at the time of performing RA in the BWP, and
average energy level for failed LBT operations at the time of performing RA in the BWP.

In some of these embodiments, in the report, the logged information associated with the first BWP and the logged information associated with each of the configured BWPs in which a RA procedure was performed are arranged in a chronological order in which the UE activated the respective BWPs.

In some embodiments, the repeated operations in block 730 include one or more failed RA procedures in respective one or more configured BWPs other than the first BWP, with each failed RA procedure being due to consistent LBT failure. In some of these embodiments, the report also includes indications of respective durations between successive consistent LBT failures detected in the successive BWPs activated by the UE.

In some embodiments, the report also includes an indication of a duration from detecting the consistent LBT failure in the first BWP until either a successful RA procedure or failed RA procedures in all configured BWPs having RA resources.

In some embodiments, when the UE performs a successful RA procedure in one of the configured BWPs, the report is a RA report and the logged information is included in a RA-InformationCommon-r16 information element (IE). FIG. 5 shows an example of these embodiments.

In other embodiments, when the UE performs failed RA procedures in all configured BWPs having RA resources, the report is a one of the following:
a radio link failure (RLF) report associated with an RLF or a handover failure (e.g., such as illustrated in FIG. 6);
an MCGFailureInformation report, associated with a failed MCG fast recovery procedure; or
an SCGFailureInformation report, associated with a SCG failure.

In some of these embodiments, the exemplary method also includes the operations of block 750, where the UE performs connection reestablishment with the RAN after failed RA procedures in all configured BWPs having RA resources. The report is transmitted in block 780 after performing connection reestablishment.

In some embodiments, the exemplary method also includes the operations of blocks 760-770, where the UE sends to the RAN an indication that the UE has stored information associated with consistent LBT failures and receives from the RAN a request for the stored information. The report is sent in block 780 in response to the request.

In addition, FIG. 8 shows an exemplary method (e.g., procedure) for a RAN node configured to serve UEs via a cell in unlicensed spectrum, according to various embodiments of the present disclosure. The exemplary method can be performed by a RAN node (e.g., base station, eNB, gNB, ng-eNB, etc.) such as described elsewhere herein.

The exemplary method includes the operations of block 840, where the RAN node receives from a UE a report including at least information associated with a first BWP in which the UE detected consistent LBT failure. The first BWP is one of a plurality of BWPs configured for the UE in unlicensed spectrum, and the consistent LBT failure is detected for an UL transmission that is unrelated to a RA procedure. The exemplary method also includes the operations of block 850, where based on the information in the report, the RAN node adjusts one or more LBT configuration parameters for UEs in a cell served by the RAN node.

In some embodiments, the information associated with the first BWP in which the UE detected consistent LBT failure includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.
   In some of these embodiments, the one or more measurements of energy level in the first BWP include one or more of the following:
most recent energy level at the time of the consistent LBT failure in the first BWP,
average energy level at the time of the consistent LBT failure in the first BWP,
average energy level for successful LBT operations at the time of the consistent LBT failure in the first BWP, and
average energy level for failed LBT operations at the time of the consistent LBT failure in the first BWP.

In some embodiments, the report also includes information associated with each of the configured BWPs in which the UE performed a RA procedure after detecting the consistent LBT failure in the first BWP. In some of these embodiments, for each of the configured BWPs in which the UE performed a RA procedure, the information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

In some variants of these embodiments, the one or more measurements of energy level in the each of the configured BWPs in which the UE performed a RA procedure include one or more of the following:
most recent energy level at the time of performing RA in the BWP,
average energy level at the time of performing RA in the BWP,
average energy level for successful LBT operations at the time of performing RA in the BWP, and
average energy level for failed LBT operations at the time of performing RA in the BWP.

In some of these embodiments, in the report, the information associated with the first BWP and the information associated with each of the configured BWPs in which the UE performed a RA procedure are arranged in a chronological order in which the UE activated the respective BWPs.

In some embodiments, the report also includes indications of respective durations between successive consistent LBT failures detected in the successive BWPs activated by the UE. In some embodiments, the report also includes an indication of a duration from detecting the consistent LBT failure in the first BWP until either a successful RA procedure or failed RA procedures in all configured BWPs having RA resources.

In some embodiments, the report is a RA report that is received after the UE performs a successful RA procedure in one of the configured BWPs, and the information is included in a RA-InformationCommon-r16 IE of the RA report. FIG. 5 shows an example of these embodiments.

In other embodiments, the report is received after the UE performs failed RA procedures in all configured BWPs having RA resources, and the report is a one of the following:
an RLF report associated with an RLF or a handover failure (e.g., such as illustrated in FIG. 6);
an MCGFailureInformation report, associated with a failed MCG fast recovery procedure; or
an SCGFailureInformation report, associated with an SCG failure.

In some of these embodiments, the exemplary method also includes the operations of block 810, where the RAN node performs connection reestablishment with the UE after failed UE RA procedures in all configured BWPs having RA resources. The report is received in block 840 after performing connection reestablishment.

In some embodiments, the exemplary method also includes the operations of blocks 820-830, where the RAN node receives from the UE an indication that the UE has stored information associated with consistent LBT failures and sends to the UE a request for the stored information. The report is received in block 840 in response to the request.

In some embodiments, adjusting one or more LBT configuration parameters for UEs based on the information in the report, in block 850, can include the following operations, labelled with corresponding sub-block numbers:
(851) determining one or more of the following information based on the information in the report:
   BWPs in which the UE detected consistent UL LBT failure;
   how many BWP switches were performed by the UE due to consistent UL LBT failures;
   duration between consistent LBT failures in multiple BWPs,
   correlation between consistent LBT failures in multiple BWPs, and
   which portion of the UE's reported LBT failures occurred during RA procedures in the shared channel; and
(852) adjusting RA configurations in BWPs in which the UE detected consistent UL LBT failure, based on the determined information.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

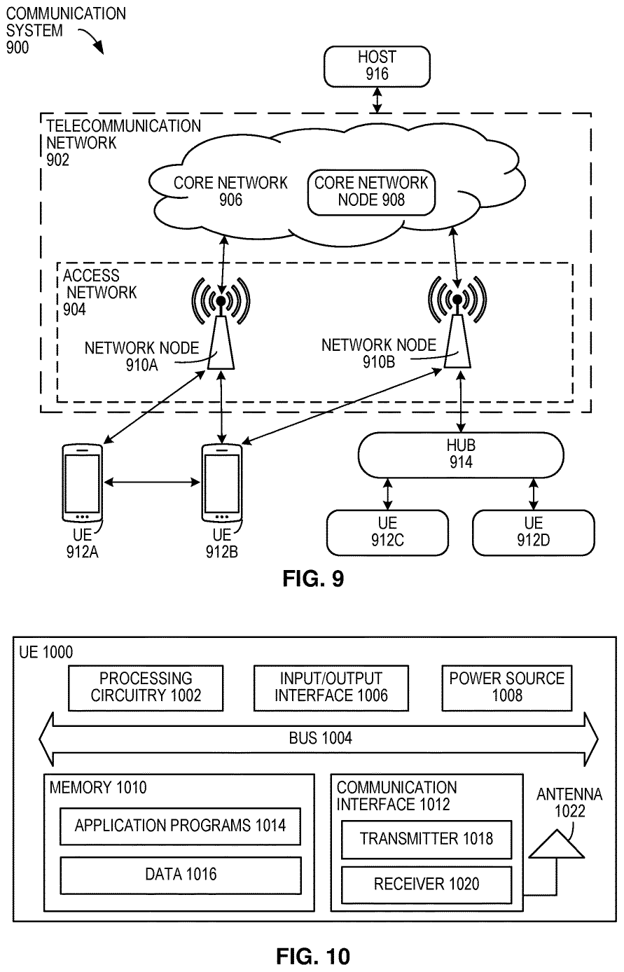

FIG. 9 shows an example of a communication system 900 in accordance with some embodiments. In this example, communication system 900 includes a telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 902 includes one or more Open-RAN (ORAN) network nodes. An ORAN network node is a node in telecommunication network 902 that supports an ORAN specification (e.g., a specification published by the O-RAN Alliance, or any similar organization) and may operate alone or together with other nodes to implement one or more functionalities of any node in telecommunication network 902, including one or more network nodes 910 and/or core network nodes 908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 910 facilitate direct or indirect connection of UEs, such as by connecting UEs 912a-d (one or more of which may be generally referred to as UEs 912) to core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, core network 906 connects network nodes 910 to one or more hosts, such as host 916. These connections may be direct or indirect via one or more intermediary networks or devices. In other examples, network nodes may be directly coupled to hosts. Core network 906 includes one or more core network nodes (e.g., 908) that are structured with hardware and software components. Features of these components may be substantially similar to those described with respect to the UEs, network nodes, and/or hosts, such that the descriptions thereof are generally applicable to the corresponding components of core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 916 may be under the ownership or control of a service provider other than an operator or provider of access network 904 and/or telecommunication network 902, and may be operated by the service provider or on behalf of the service provider. Host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 914 communicates with access network 904 to facilitate indirect communication between one or more UEs (e.g., 912c and/or 912d) and network nodes (e.g., network node 910b). In some examples, hub 914 may be a controller, router, content source and analytics, or any of the other communication devices described herein regarding UEs. For example, hub 914 may be a broadband router enabling access to core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, in particular if one or more of the UEs are low energy IoT devices.

Hub 914 may have a constant/persistent or intermittent connection to network node 910b. Hub 914 may also allow for a different communication scheme and/or schedule between hub 914 and UEs (e.g., 912c and/or 912d), and between hub 914 and core network 906. In other examples, hub 914 is connected to core network 906 and/or one or more UEs via a wired connection. Moreover, hub 914 may be configured to connect to an M2M service provider over access network 904 and/or to another UE over a direct connection. In some scenarios, UEs may establish a wireless connection with network nodes 910 while still connected via hub 914 via a wired or wireless connection. In some embodiments, hub 914 may be a dedicated hub—that is, a hub whose primary function is to route communications to/from the UEs from/to network node 910b. In other embodiments, hub 914 may be a non-dedicated hub—that is, a device which is capable of operating to route communications between the UEs and network node 910b, but which is additionally capable of operating as a communication start and/or end point for certain data channels.

In some embodiments, one or more of UEs 912 can be configured to perform operations attributed to a UE in various methods, procedures, and/or techniques described above, including in relation to FIGS. 7-8. Likewise, in some embodiments, one or more of network nodes 910 can be configured to perform operations attributed to a RAN node in various methods, procedures, and/or techniques described above, including in relation to FIGS. 7-8.

FIG. 10 shows a UE 1000 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

Processing circuitry 1002 is configured to process instructions and data and may be configured to implement any sequential state machine operative to execute instructions stored as machine-readable computer programs in memory 1010. Processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1002 may include multiple central processing units (CPUs).

In the example, input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1008 is structured as a battery or battery pack. Other types of power sources, such as an external power source (e.g., an electricity outlet), photovoltaic device, or power cell, may be used. Power source 1008 may further include power circuitry for delivering power from power source 1008 itself, and/or an external power source, to the various parts of UE 1000 via input circuitry or an interface such as an electrical power cable. Delivering power may be, for example, for charging of power source 1008. Power circuitry may perform any formatting, converting, or other modification to the power from power source 1008 to make the power suitable for the respective components of UE 1000 to which power is supplied.

Memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1010 includes one or more application programs 1014, such as an operating system, web browser application, a widget, gadget engine, or other application, and corresponding data 1016. Memory 1010 may store, for use by UE 1000, any of a variety of various operating systems or combinations of operating systems.

Memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1010 may allow UE 1000 to access instructions, application programs and the like, stored on transitory or non-transitory memory media, to off-load data, or to upload data. An article of manufacture, such as one utilizing a communication system may be tangibly embodied as or in memory 1010, which may be or comprise a device-readable storage medium.

Processing circuitry 1002 may be configured to communicate with an access network or other network using communication interface 1012. Communication interface 1012 may comprise one or more communication subsystems and may include or be communicatively coupled to an antenna 1022. Communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, transmitter 1018 and receiver 1020 may be coupled to one or more antennas (e.g., antenna 1022) and may share circuit components, software or firmware, or alternatively be implemented separately.

In the illustrated embodiment, communication functions of communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

In some embodiments, UE 1000 can be configured to perform operations attributed to a UE in various methods, procedures, and/or techniques described above, including in relation to FIGS. 7-8.

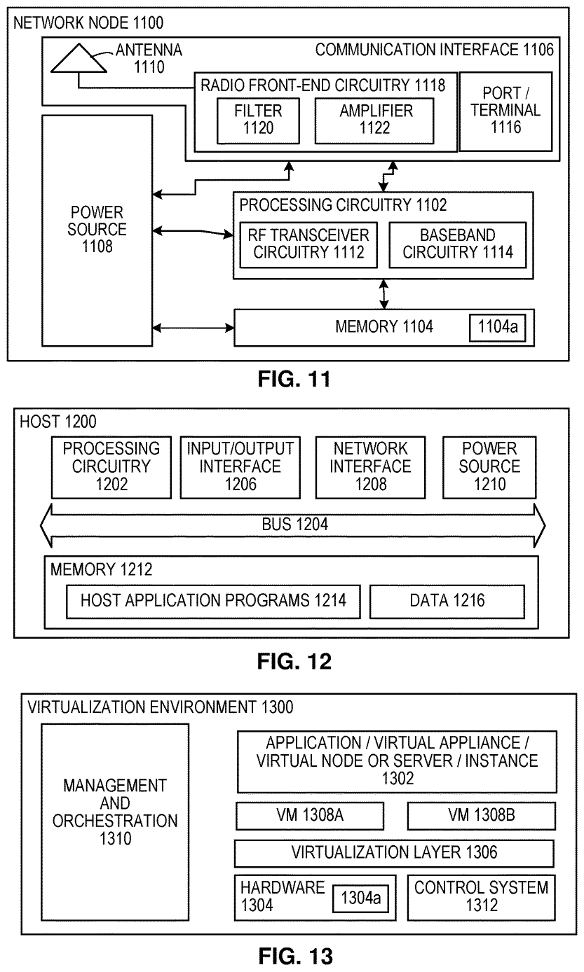

FIG. 11 shows a network node 1100 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1100 includes a processing circuitry 1102, a memory 1104, a communication interface 1106, and a power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, the processing circuitry 1102 includes a system on a chip (SOC). In some embodiments, the processing circuitry 1102 includes radio frequency (RF) transceiver circuitry 1112 and/or baseband processing circuitry 1114. In some embodiments, RF transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. Memory 1104 may store any suitable instructions, data, or information, including a computer program, software, an application including one or more of logic, rules, code, tables, and/or other instructions (collected denoted computer program 1104a, which may be in the form of a computer program product) capable of being executed by the processing circuitry 1102 and utilized by network node 1100. Memory 1104 may be used to store any calculations made by the processing circuitry 1102 and/or any data received via communication interface 1106. In some embodiments, the processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. The radio front-end circuitry may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to the processing circuitry 1102. In other embodiments, the communication interface may comprise different components and/or different combinations of components.

In certain alternative embodiments, network node 1100 does not include separate radio front-end circuitry 1118, instead, the processing circuitry 1102 includes radio front-end circuitry and is connected to antenna 1110. Similarly, in some embodiments, all or some of RF transceiver circuitry 1112 is part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or the processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

In some embodiments, network node 1100 can be configured to perform operations attributed to a RAN node in various methods, procedures, and/or techniques described above, including in relation to FIGS. 7-8.

FIG. 12 is a block diagram of a host 1200, which may be an embodiment of host 916 of FIG. 9, in accordance with various aspects described herein. As used herein, host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize only a subset or all of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1300 includes components defined by the O-RAN Alliance, such as an O-Cloud environment orchestrated by a Service Management and Orchestration Framework via an O-2 interface.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein. In some embodiments, virtualization environment 1300 can host and/or implement one or more virtual nodes 1302 that are configured to perform operations attributed to a RAN node in various methods, procedures, and/or techniques described above, including in relation to FIGS. 7-8.

Hardware 1304 includes processing circuitry, memory that stores software and/or instructions (collected denoted computer program 1304a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. Virtualization layer 1306 may present a virtual operating platform that appears like networking hardware to VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1308 may be a software implementation of a physical machine that runs programs as if they were executed on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration function 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

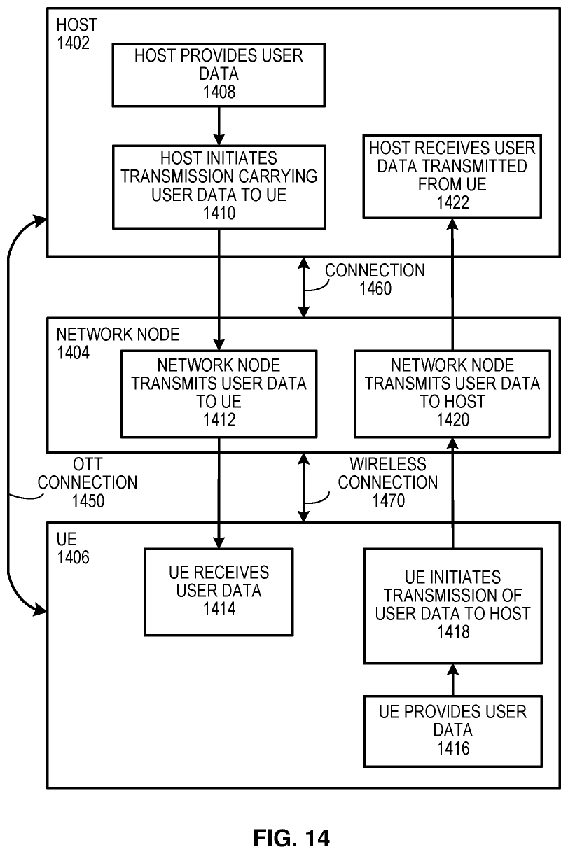

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. Host 1402 also includes software, which is stored in or accessible by host 1402 and executable by the processing circuitry. The software includes a host application that may be operable to provide a service to a remote user, such as UE 1406 connecting via an over-the-top (OTT) connection 1450 extending between UE 1406 and host 1402. In providing the service to the remote user, a host application may provide user data which is transmitted using OTT connection 1450.

Network node 1404 includes hardware enabling it to communicate with host 1402 and UE 1406. Connection 1460 may be direct or pass through a core network (like core network 906 of FIG. 9) and/or one or more other intermediate networks, such as one or more public, private, or hosted networks. For example, an intermediate network may be a backbone network or the Internet.

UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of host 1402. In host 1402, an executing host application may communicate with the executing client application via OTT connection 1450 terminating at UE 1406 and host 1402. In providing the service to the user, the UE's client application may receive request data from the host's host application and provide user data in response to the request data. OTT connection 1450 may transfer both the request data and the user data. The UE's client application may interact with the user to generate the user data that it provides to the host application through OTT connection 1450.

OTT connection 1450 may extend via a connection 1460 between host 1402 and network node 1404 and via a wireless connection 1470 between network node 1404 and UE 1406 to provide the connection between host 1402 and UE 1406. Connection 1460 and wireless connection 1470, over which OTT connection 1450 may be provided, have been drawn abstractly to illustrate the communication between host 1402 and UE 1406 via network node 1404, without explicit reference to any intermediary devices and the precise routing of messages via these devices.

As an example of transmitting data via OTT connection 1450, in step 1408, host 1402 provides user data, which may be performed by executing a host application. In some embodiments, the user data is associated with a particular human user interacting with UE 1406. In other embodiments, the user data is associated with a UE 1406 that shares data with host 1402 without explicit human interaction. In step 1410, host 1402 initiates a transmission carrying the user data towards UE 1406. Host 1402 may initiate the transmission responsive to a request transmitted by UE 1406. The request may be caused by human interaction with UE 1406 or by operation of the client application executing on UE 1406. The transmission may pass via network node 1404, in accordance with the teachings of the embodiments described throughout this disclosure. Accordingly, in step 1412, network node 1404 transmits to UE 1406 the user data that was carried in the transmission that host 1402 initiated, in accordance with the teachings of the embodiments described throughout this disclosure. In step 1414, UE 1406 receives the user data carried in the transmission, which may be performed by a client application executed on UE 1406 associated with the host application executed by host 1402.

In some examples, UE 1406 executes a client application which provides user data to host 1402. The user data may be provided in reaction or response to the data received from host 1402. Accordingly, in step 1416, UE 1406 may provide user data, which may be performed by executing the client application. In providing the user data, the client application may further consider user input received from the user via an input/output interface of UE 1406. Regardless of the specific manner in which the user data was provided, UE 1406 initiates, in step 1418, transmission of the user data towards host 1402 via network node 1404. In step 1420, in accordance with the teachings of the embodiments described throughout this disclosure, network node 1404 receives user data from UE 1406 and initiates transmission of the received user data towards host 1402. In step 1422, host 1402 receives the user data carried in the transmission initiated by UE 1406.

One or more of the various embodiments improve the performance of OTT services provided to UE 1406 using OTT connection 1450, in which wireless connection 1470 forms the last segment. More precisely, embodiments may improve operation of UEs and RAN nodes in unlicensed spectrum. For example, For example, by receiving UE information and measurements pertaining to a first BWP in which the UE initially detected the consistent LBT failure, the RAN can create a more complete picture of consistent LBT failures detected by the UEs. Moreover, based on receiving information about the list of BWPs configured at the UE at the time of consistent LBT failure(s), the RAN can better understand UE behavior in selecting other BWPs upon detecting an initial consistent LBT failure, enabling the RAN to better allocate RA resources in configured BWPs. Furthermore, embodiments enable the RAN to identify BWPs that are correlated for consistent LBT failures, so the RAN can avoid allocating RA resources in correlated BWPs. In this manner, the RAN can adjust and/or optimize UL LBT and/or RA settings for UEs operating in the cell based on the information reported by UEs. These improvements can lead to better utilization of shared spectrum for delivering OTT services to end users, which increases the value of such services to end users and service providers.

In an example scenario, factory status information may be collected and analyzed by host 1402. As another example, host 1402 may process audio and video data which may have been retrieved from a UE for use in creating maps. As another example, host 1402 may collect and analyze real-time data to assist in controlling vehicle congestion (e.g., controlling traffic lights). As another example, host 1402 may store surveillance video uploaded by a UE. As another example, host 1402 may store or control access to media content such as video, audio, VR or AR which it can broadcast, multicast or unicast to UEs. As other examples, host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1450 between host 1402 and UE 1406, in response to variations in the measurement results. The measurement procedure and/or the network functionality for reconfiguring the OTT connection may be implemented in software and hardware of host 1402 and/or UE 1406. In some embodiments, sensors (not shown) may be deployed in or in association with other devices through which OTT connection 1450 passes; the sensors may participate in the measurement procedure by supplying values of the monitored quantities exemplified above, or supplying values of other physical quantities from which software may compute or estimate the monitored quantities. The reconfiguring of OTT connection 1450 may include message format, retransmission settings, preferred routing etc.; the reconfiguring need not directly alter the operation of network node 1404. Such procedures and functionalities may be known and practiced in the art. In certain embodiments, measurements may involve proprietary UE signaling that facilitates measurements of throughput, propagation times, latency and the like, by host 1402. The measurements may be implemented in that software causes messages to be transmitted, in particular empty or ‘dummy’ messages, using OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured to operate in unlicensed spectrum in a radio access network (RAN), the method comprising:
   initiating an uplink (UL) transmission in an active first bandwidth (BWP) of a plurality of configured BWPs in unlicensed spectrum, wherein the UL transmission is unrelated to a random access (RA) procedure;
   detecting consistent LBT failure in the first BWP and logging information associated with the first BWP in which the consistent LBT failure was detected;
   repeating the following operations until a successful RA procedure or failed RA procedures in all configured BWPs having RA resources:
      deactivating the active BWP,
      activating another of the configured BWPs having RA resources, and
      performing a RA procedure in the active BWP;
   subsequently sending to the RAN a report including at least the logged information associated with the first BWP.
A2. The method of embodiment A1, wherein the logged information associated with the first BWP in which the consistent LBT failure was detected includes one or more of the following:
   location in frequency and bandwidth of the first BWP;
   subcarrier spacing of the first BWP;
   number of LBT failures detected in the first BWP;
   indication of whether the number of LBT failures detected in the first BWP is larger than a threshold;
   an identifier associated with the first BWP;
   one or more measurements of energy level in the first BWP; and
   reason for initiating the UL transmission in the first BWP.
A3. The method of embodiment A2, wherein the one or more measurements of energy level in the first BWP include one or more of the following:
   most recent energy level at the time of the consistent LBT failure in the first BWP,
   average energy level at the time of the consistent LBT failure in the first BWP,
   average energy level for successful LBT operations at the time of the consistent LBT failure in the first BWP, and
   average energy level for failed LBT operations at the time of the consistent LBT failure in the first BWP.
A4. The method of any of embodiments A1-A3, further comprising logging information associated with each of the configured BWPs in which a RA procedure was performed, wherein the report includes the logged information associated with each of the configured BWPs in which a RA procedure was performed.
A5. The method of embodiment A4, wherein for each of the configured BWPs in which a RA procedure was performed, the logged information includes one or more of the following:
   location in frequency and bandwidth of the BWP,
   subcarrier spacing of the BWP,
   numbers of LBT failures detected in the BWP,
   an identifier associated with the BWP, and
   one or more measurements of energy level in the BWP.
A6. The method of embodiment A5, wherein the one or more measurements of energy level in the each of the configured BWPs in which a RA procedure was performed include one or more of the following:
   most recent energy level at the time of performing RA in the BWP,
   average energy level at the time of performing RA in the BWP,
   average energy level for successful LBT operations at the time of performing RA in the BWP, and
   average energy level for failed LBT operations at the time of performing RA in the BWP.
A7. The method of any of embodiments A4-A6, wherein in the report, the logged information associated with the first BWP and the logged information associated with each of the configured BWPs in which a RA procedure was performed are arranged in a chronological order in which the UE activated the respective BWPs.
A8. The method of any of embodiments A1-A7, wherein the repeated operations include one or more failed RA procedures in respective one or more configured BWPs other than the first BWP, with each failed RA procedure being due to consistent LBT failure.
A9. The method of embodiment A8, wherein the report also includes indications of respective durations between successive consistent LBT failures detected in the successive BWPs activated by the UE.
A10. The method of any of embodiments A1-A9, wherein the report also includes an indication of a duration from detecting the consistent LBT failure in the first BWP until either a successful RA procedure or failed RA procedures in all configured BWPs having RA resources.
A11. The method of any of embodiments A1-A10, wherein when the UE performs a successful RA procedure in one of the configured BWPs, the report is a RA report and the logged information is included in a RA-InformationCommon-r16 information element (IE).
A12. The method of any of embodiments A1-A10, wherein when the UE performs failed RA procedures in all configured BWPs having RA resources, the report is a one of the following:
   a radio link failure (RLF) report associated with an RLF or a handover failure;
   an MCGFailureInformation report, associated with a failed master cell group (MCG) fast recovery procedure; or
   an SCGFailureInformation report, associated with a secondary cell group (SCG) failure.
A13. The method of embodiment A12, further comprising performing connection reestablishment with the RAN after failed RA procedures in all configured BWPs having RA resources, wherein the report is transmitted after performing connection reestablishment.
A14. The method of any of embodiments A1-A13, further comprising:
   sending to the RAN node an indication that the UE has stored information associated with consistent LBT failures; and
   receiving from the RAN node a request for the stored information,
   wherein the report is sent to the RAN node in response to the request.
B1. A method for a radio access network (RAN) node configured serve user equipment (UEs) via a cell in unlicensed spectrum, the method comprising:
   receiving from a UE a report including at least information associated with a first bandwidth (BWP) in which the UE detected consistent listen-before-talk (LBT) failure, wherein:
      the first BWP is one of a plurality of BWPs configured for the UE in unlicensed spectrum, and
      the consistent LBT failure is detected for an uplink (UL) transmission that is unrelated to a random access (RA) procedure; and
   based on the information in the report, adjusting one or more LBT configuration parameters for UEs in a cell served by the RAN node.
B2. The method of embodiment B1, wherein the information associated with the first BWP in which the UE detected consistent LBT failure includes one or more of the following:
   location in frequency and bandwidth of the first BWP;
   subcarrier spacing of the first BWP;
   number of LBT failures detected in the first BWP;
   indication of whether the number of LBT failures detected in the first BWP is larger than a threshold;
   an identifier associated with the first BWP;
   one or more measurements of energy level in the first BWP; and
   reason for initiating the UL transmission in the first BWP.
B3. The method of embodiment B2, wherein the one or more measurements of energy level in the first BWP include one or more of the following:
   most recent energy level at the time of the consistent LBT failure in the first BWP,
   average energy level at the time of the consistent LBT failure in the first BWP,
   average energy level for successful LBT operations at the time of the consistent LBT failure in the first BWP, and
   average energy level for failed LBT operations at the time of the consistent LBT failure in the first BWP.
B4. The method of any of embodiments B1-B3, wherein the report also includes information associated with each of the configured BWPs in which the UE performed a RA procedure after detecting the consistent LBT failure in the first BWP.
B5. The method of embodiment B4, wherein for each of the configured BWPs in which the UE performed a RA procedure, the information includes one or more of the following:
   location in frequency and bandwidth of the BWP,
   subcarrier spacing of the BWP,
   numbers of LBT failures detected in the BWP,
   an identifier associated with the BWP, and
   one or more measurements of energy level in the BWP.
B6. The method of embodiment B5, wherein the one or more measurements of energy level in the each of the configured BWPs in which the UE performed a RA procedure include one or more of the following:
   most recent energy level at the time of performing RA in the BWP,
   average energy level at the time of performing RA in the BWP,
   average energy level for successful LBT operations at the time of performing RA in the BWP, and
   average energy level for failed LBT operations at the time of performing RA in the BWP.
B7. The method of any of embodiments B4-B6, wherein in the report, the information associated with the first BWP and the information associated with each of the configured BWPs in which the UE performed a RA procedure are arranged in a chronological order in which the UE activated the respective BWPs.
B8. The method of any of embodiments B1-B7, wherein the report also includes indications of respective durations between successive consistent LBT failures detected in the successive BWPs activated by the UE.
B9. The method of any of embodiments B1-B8, wherein the report also includes an indication of a duration from detecting the consistent LBT failure in the first BWP until either a successful RA procedure or failed RA procedures in all configured BWPs having RA resources.
B10. The method of any of embodiments B1-B9, wherein the report is a RA report that is received after the UE performs a successful RA procedure in one of the configured BWPs, and the information is included in a RA-InformationCommon-r16 information element (IE) of the RA report.
B11. The method of any of embodiments B1-B9, wherein the report is received after the UE performs failed RA procedures in all configured BWPs having RA resources, and the report is a one of the following:
   a radio link failure (RLF) report associated with an RLF or a handover failure;
   an MCGFailureInformation report, associated with a failed master cell group (MCG) fast recovery procedure; or
   an SCGFailureInformation report, associated with a secondary cell group (SCG) failure.
B12. The method of embodiment B11, further comprising performing connection reestablishment with the UE after failed UE RA procedures in all configured BWPs having RA resources, wherein the report is received after performing connection reestablishment.
B13. The method of any of embodiment B1-B12, further comprising:
   receiving from the UE an indication that the UE has stored information associated with consistent LBT failures; and
   sending to the UE a request for the stored information,
   wherein the report is received from the UE in response to the request.
B14. The method of any of embodiments B1-B13, wherein adjusting one or more LBT configuration parameters for UEs based on the information in the report comprises one or more of the following:
   determining one or more of the following information based on the information in the report:
      BWPs in which the UE detected consistent UL LBT failure,
      how many BWP switches were performed by the UE due to consistent UL LBT failures,
      duration between consistent LBT failures in multiple BWPs,
      correlation between consistent LBT failures in multiple BWPs, and
      which portion of the UE's reported LBT failures occurred during RA procedures; and
   adjusting RA configurations in BWPs in which the UE detected consistent UL LBT failure, based on the determined information.
C1. A user equipment (UE) configured to operate in unlicensed spectrum in a radio access network (RAN), the UE comprising:
   communication interface circuitry configured to communicate with at least one RAN node; and
   processing circuitry operatively coupled to the communication interface circuitry, whereby the processing circuitry and the communication interface circuitry are configured to perform operations corresponding to the methods of any of embodiments A1-A14.
C2. A user equipment (UE) configured to operate in unlicensed spectrum in a radio access network (RAN), the UE being further arranged to perform operations corresponding to the methods of any of embodiments A1-A14.
C3. A non-transitory, computer-readable medium storing computer-executable instructions that, when executed by processing circuitry of a user equipment (UE) configured to operate in unlicensed spectrum in a radio access network (RAN), configure the UE to perform operations corresponding to the methods of any of embodiments A1-A14.
C4. A computer program product comprising computer-executable instructions that, when executed by processing circuitry of a user equipment (UE) configured to operate in unlicensed spectrum in a radio access network (RAN), configure the UE to perform operations corresponding to the methods of any of embodiments A1-A14.
D1. A radio access network (RAN) node configured to serve user equipment (UEs) via a cell in unlicensed spectrum, the RAN node comprising:
   communication interface circuitry configured to communicate with UEs; and
   processing circuitry operatively coupled to the communication interface circuitry, whereby the processing circuitry and the communication interface circuitry are configured to perform operations corresponding to the methods of any of embodiments B1-B14.
D2. A radio access network (RAN) node configured to serve user equipment (UEs) via a cell in unlicensed spectrum, the RAN node being further arranged to perform operations corresponding to the methods of any of embodiments B1-B14.
D3. A non-transitory, computer-readable medium storing computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B14.
D4. A computer program product comprising computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B14.

1-40. (canceled)

41. A method for a user equipment (UE) configured to operate in unlicensed spectrum in a radio access network (RAN) the method comprising:
initiating an uplink (UL) transmission in an active first bandwidth part (BWP) of a plurality of configured BWPs in unlicensed spectrum, wherein the UL transmission is unrelated to a random access (RA) procedure;
detecting consistent listen-before-talk (LBT) failure in the first BWP and logging information associated with the first BWP in which the consistent LBT failure was detected;
repeating the following operations until an RA procedure in an active BWP succeeds or RA procedures fail in all configured BWPs having RA resources:
deactivating the active BWP,
activating another of the configured BWPs having RA resources, and
performing an RA procedure in the active BWP; and
subsequently sending to the RAN a report including at least the logged information associated with the first BWP.

42. The method of claim 41, wherein the logged information associated with the first BWP in which the consistent LBT failure was detected includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.

43. The method of claim 42, wherein the one or more measurements of energy level in the first BWP include one or more of the following:
most recent energy level at the time of the consistent LBT failure in the first BWP,
average energy level at the time of the consistent LBT failure in the first BWP,
average energy level for successful LBT operations at the time of the consistent LBT failure in the first BWP, and
average energy level for failed LBT operations at the time of the consistent LBT failure in the first BWP.

44. The method of claim 41, further comprising logging information associated with each of the configured BWPs in which a RA procedure was performed, wherein the report includes the logged information associated with each of the configured BWPs in which a RA procedure was performed.

45. The method of claim wherein for each of the configured BWPs in which a RA procedure was performed, the logged information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

46. The method of claim 45, wherein the one or more measurements of energy level in the each of the configured BWPs in which a RA procedure was performed include one or more of the following:
most recent energy level at the time of performing RA in the BWP,
average energy level at the time of performing RA in the BWP,
average energy level for successful LBT operations at the time of performing RA in the BWP, and
average energy level for failed LBT operations at the time of performing RA in the BWP.

47. The method of claim 44, wherein in the report, the logged information associated with the first BWP and the logged information associated with each of the configured BWPs in which a RA procedure was performed are arranged in a chronological order in which the UE activated the respective BWPs.

48. The method of claim 41, wherein the repeated operations include one or more failed RA procedures in respective one or more configured BWPs other than the first BWP, with each failed RA procedure being due to consistent LBT failure.

49. The method of claim 48, wherein the report also includes indications of respective durations between successive consistent LBT failures detected in the successive BWPs activated by the UE.

50. The method of claim 41, wherein the report also includes an indication of a duration from detecting the consistent LBT failure in the first BWP until either a successful RA procedure or failed RA procedures in all configured BWPs having RA resources.

51. A method for a radio access network (RAN) node configured serve user equipment (UEs) via a cell in unlicensed spectrum, the method comprising:
receiving from a UE a report including at least information associated with a first bandwidth part (BWP) in which the UE detected consistent listen-before-talk (LBT) failure, wherein:
the first BWP is one of a plurality of BWPs configured for the UE in unlicensed spectrum, and
the consistent LBT failure is detected for an uplink (UL) transmission that is unrelated to a random access (RA) procedure; and
based on the information in the report, adjusting one or more LBT configuration parameters for UEs in a cell served by the RAN node.

52. The method of claim 51, wherein the information associated with the first BWP in which the UE detected consistent LBT failure includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.

53. The method of claim 52, wherein the one or more measurements of energy level in the first BWP include one or more of the following:
most recent energy level at the time of the consistent LBT failure in the first BWP,
average energy level at the time of the consistent LBT failure in the first BWP,
average energy level for successful LBT operations at the time of the consistent LBT failure in the first BWP, and
average energy level for failed LBT operations at the time of the consistent LBT failure in the first BWP.

54. The method of claim 51, wherein the report also includes information associated with each of the configured BWPs in which the UE performed a RA procedure after detecting the consistent LBT failure in the first BWP.

55. The method of claim 54, wherein for each of the configured BWPs in which the UE performed a RA procedure, the information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

56. The method of claim 55, wherein the one or more measurements of energy level in the each of the configured BWPs in which the UE performed a RA procedure include one or more of the following:
most recent energy level at the time of performing RA in the BWP,
average energy level at the time of performing RA in the BWP,
average energy level for successful LBT operations at the time of performing RA in the BWP, and
average energy level for failed LBT operations at the time of performing RA in the BWP.

57. The method of claim 54, wherein in the report, the information associated with the first BWP and the information associated with each of the configured BWPs in which the UE performed a RA procedure are arranged in a chronological order in which the UE activated the respective BWPs.

58. The method of claim 51, wherein the report also includes indications of respective durations between successive consistent LBT failures detected in the successive BWPs activated by the UE.

59. User equipment (UE) configured to operate in unlicensed spectrum in a radio access network (RAN), the UE comprising:
communication interface circuitry configured to communicate with at least one RAN node; and
processing circuitry operatively coupled to the communication interface circuitry, wherein the processing circuitry and the communication interface circuitry are configured to:
initiate an uplink (UL) transmission in an active first bandwidth part (BWP) of a plurality of configured BWPs in unlicensed spectrum, wherein the UL transmission is unrelated to a random access (RA) procedure;
detect consistent listen-before-talk (LBT) failure in the first BWP and log information associated with the first BWP in which the consistent LBT failure was detected;
repeat the following operations until an RA procedure in an active BWP succeeds or RA procedures fail in all configured BWPs having RA resources:
deactivating the active BWP,
activating another of the configured BWPs having RA resources, and
performing an RA procedure in the active BWP; and
subsequently send to the RAN a report including at least the logged information associated with the first BWP.

60. The UE of claim 59, wherein the logged information associated with the first BWP in which the consistent LBT failure was detected includes one or more of the following:
location in frequency and bandwidth of the first BWP;
subcarrier spacing of the first BWP;
number of LBT failures detected in the first BWP;
indication of whether the number of LBT failures detected in the first BWP is larger than a threshold;
an identifier associated with the first BWP;
one or more measurements of energy level in the first BWP; and
reason for initiating the UL transmission in the first BWP.

61. The UE of claim 59, wherein:
the processing circuitry and the communication interface circuitry are further configured to log information associated with each of the configured BWPs in which a RA procedure was performed;
the report includes the logged information associated with each of the configured BWPs in which a RA procedure was performed; and
for each of the configured BWPs in which a RA procedure was performed, the logged information includes one or more of the following:
location in frequency and bandwidth of the BWP,
subcarrier spacing of the BWP,
numbers of LBT failures detected in the BWP,
an identifier associated with the BWP, and
one or more measurements of energy level in the BWP.

62. Radio access network (RAN) node configured to serve user equipment (UEs) via a cell in unlicensed spectrum, the RAN node comprising communication interface circuitry and processing circuitry that are operably coupled and configured to perform the method of claim 51.
